(19) United States
(12) Patent Application Publication
(10) Pub. No.: US 2020/0274419 A1
(43) Pub. Date: Aug. 27, 2020

(54) MOTOR

(71) Applicant: NIDEC SANKYO CORPORATION, NAGANO (JP)

(72) Inventors: Hiroyuki HATASAKO, NAGANO (JP); Hidekazu YONEYAMA, NAGANO (JP); Takafumi KASUGA, NAGANO (JP); Takahisa UEKI, NAGANO (JP)

(73) Assignee: NIDEC SANKYO CORPORATION, NAGANO (JP)

(21) Appl. No.: 16/647,021

(22) PCT Filed: Jul. 23, 2018
(86) PCT No.: PCT/JP2018/027424

§ 371 Date: Mar. 13, 2020

(30) Foreign Application Priority Data
Sep. 15, 2017 (JP) 2017-177353

(51) Int. Cl. H02K 5/22; H02K 11/33

(52) U.S. Cl. CPC H02K 5/225; H02K 3/50; H02K 11/33

(57) ABSTRACT

To provide a motor in which a coil wire of a drive coil is prevented from breaking or being damaged. A motor includes: a motor case including an opening unit formed therein and housing a drive coil; a frame attached to the motor case; a substrate holding member fixed to the frame; and a power supply substrate held by the substrate holding member. In the motor, a coil wire of the drive coil is led out through the opening unit and is electrically connected to the power supply substrate.

### TECHNICAL FIELD

The present invention relates to a motor.

### BACKGROUND ART

Patent Literatures 1 and 2 disclose a connection structure between a terminal and a power supply substrate in a motor. In the connection structures, an opening unit is formed in the motor case that houses the drive coil, and a terminal pin electrically connected to the terminal portion of the drive coil protrudes outside through the opening unit. The power supply substrate is held by a substrate holding member attached to the opening unit of the motor case, and is soldered to the terminal pin to be electrically connected to the terminal pin.

### CITATION LIST

### Patent Literature

[Patent Literature 1] Japanese Unexamined Patent Application Publication No. H10-94214

[Patent Literature 2] Japanese Unexamined Patent Application Publication No. 2011-250492

### SUMMARY OF THE INVENTION

### Problems to be Solved by the Invention

In the connection structures described in Patent Literatures 1 and 2, an engaging protrusion formed on the substrate holding member is engaged with the inner peripheral edge of the opening unit of the motor case, and thereby the substrate holding member is fixed. Therefore, when the engaging protrusion is inserted into the opening unit, the engaging protrusion may come into contact with the terminal portion led out from the drive coil, and thus there is a risk of breakage or damage of the coil wire of the drive coil.

Therefore, an object of the present invention is to provide a motor in which a coil wire of a drive coil is prevented from breaking or being damaged.

### Means for Solving the Problem

To solve the above-described object, a motor according to the present invention includes a motor case including an opening unit formed therein and housing a drive coil, a frame attached to the motor case, a substrate holding member fixed to the frame, and a power supply substrate held by the substrate holding member, and a coil wire of the drive coil is led out through the opening unit and is electrically connected to the power supply substrate.

In the motor, breakage and damage of the coil wire of the drive coil can be prevented.

In an aspect of the present invention, it is preferable that the motor case includes a cylindrical outer peripheral surface surrounding the drive coil, the opening unit is provided in the cylindrical outer peripheral surface, a terminal block protruding, through the opening unit, radially outward with respect to the cylindrical outer peripheral surface, and a terminal pin held by the terminal block and wound with the coil wire are included, and the power supply substrate is held by the substrate holding member with a predetermined gap being provided between the power supply substrate and the terminal block. Further, it is preferable that the substrate holding member includes a cutout unit through which the terminal pin extends, and a substrate placement unit on which the power supply substrate is disposed, and the substrate placement unit is provided at an outer periphery of the cutout unit. As a result, it is possible to reduce the possibility that the power supply substrate comes into contact with the terminal block or the substrate holding member comes into contact with the terminal block or the terminal pin.

Further, it is preferable that the substrate holding member includes a wall unit extending from the substrate placement unit toward the cylindrical outer peripheral surface, and an edge unit of the wall unit extends beyond the opening unit in a direction opposite to the direction in which the terminal pin protrudes, and covers at least a part of the cylindrical outer peripheral surface. As a result, it is possible to prevent dust etc. from entering the inside of the motor case through an opening unit.

In an aspect of the present invention, it is preferable that the frame includes a first attachment unit to which the substrate holding member is attached, and a second attachment unit to which the motor case is attached, a rotor is disposed inside the motor case, and the substrate holding member includes a first contact unit in contact with the first attachment unit in an axial direction of the rotor. Further, it is preferable that the substrate holding member includes a second contact unit protruding in the axial direction from the first contact unit, and the second contact unit is in contact with the first attachment unit in the direction in which the terminal pin protrudes, and the substrate holding member includes a third contact unit protruding in the axial direction from the first contact unit, and the third contact unit is in contact with the first attachment unit in a direction orthogonal to the axial direction and the direction in which the terminal pin protrudes. As a result, the substrate holding member can be fixed to the frame so as to be positioned in each of three directions, which are the axial direction, the direction in which the terminal pin protrudes, and the direction orthogonal to these directions.

Further, it is preferable that the substrate placement unit is provided with a plurality of engaging claw units engaging with the power supply substrate, and a cutout unit into which each of the engaging claw units fits is formed in an outer peripheral edge of the power supply substrate, and, each of the engaging claw units includes an extending unit extending from the substrate placement unit, and a claw unit provided at an end of the extending unit and being in contact with the power supply substrate, and the extending unit is fitted in the cutout unit. As a result, the power supply substrate can be positioned with respect to the substrate placement unit.

In an aspect of the present invention, it is preferable that the frame is attached to the motor case on one side in the axial direction of the motor, and the substrate holding member includes an end plate unit partially covering an end surface of the motor on the other side in the axial direction of the motor. In this case, it is preferable that the end plate unit is in contact with the end surface on the other side. As a result, the substrate holding member can be stably held and oriented.

The motor according to the present invention may include a movable member configured to be moved by driving force by the motor, and a position detector configured to detect a movement position of the movable member, and the position detector may be attached to the power supply substrate. In this case, it is preferable that the frame includes a plate unit, the plate unit is opposed to the power supply substrate with the position detector interposed therebetween, and the plate unit faces the position detector with a predetermined gap formed therebetween. As a result, even if the position detector is detached from the power supply substrate, it is possible to prevent the position detector from dropping off.

### Effect of the Invention

As mentioned above, according to the present invention, a motor in which a coil wire of a drive coil is prevented from breaking or being damaged can be provided.

### BRIEF DESCRIPTION OF THE DRAWINGS

FIG. 1 is a schematic perspective view of a motor according to an embodiment of the present invention.

FIG. 2 is a schematic side view of the motor according to the present embodiment.

FIG. 3 is a schematic exploded perspective view of the motor according to the present embodiment.

FIG. 4 is a schematic front view of the motor according to the present embodiment.

FIG. 5 is a schematic perspective view of a frame and a substrate holding member in the present embodiment.

### MODE FOR CARRYING OUT THE INVENTION

Embodiments of the present invention now will be described with reference to the drawings.

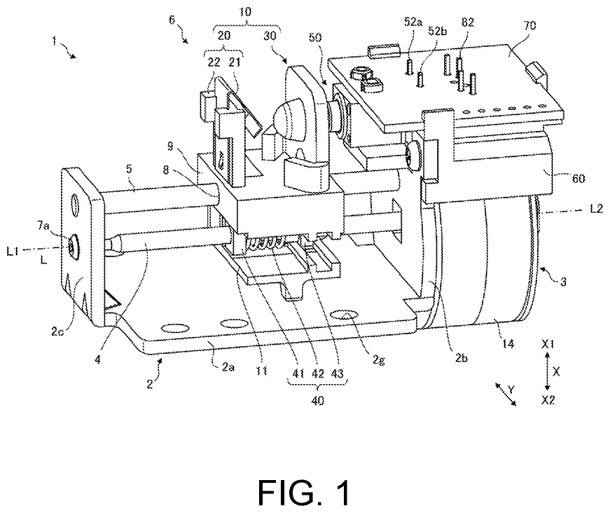

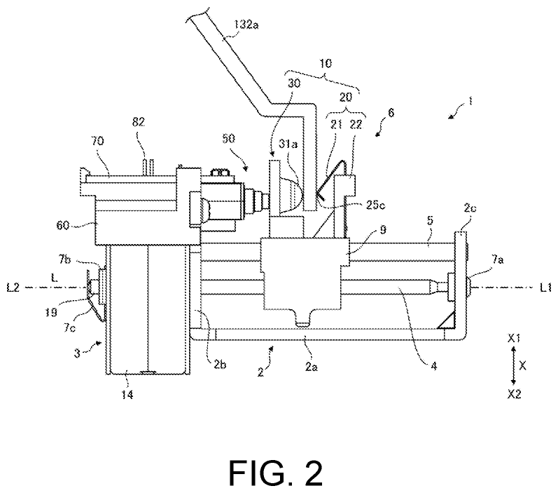

First, a motor according to an embodiment of the present invention will be described with reference to FIGS. 1 and 2. FIG. 1 is a schematic perspective view of the motor according to the embodiment, and FIG. 2 is a schematic side view of the motor according to the present embodiment. In FIGS. 1 and 2, a state in which a member to be supported is supported is illustrated. In the following description, in a direction in which an axis L of a lead screw 4 (a shaft 19) extends, one side toward which the lead screw 4 protrudes is defined as an output side L1, and the opposite side (the other side) to the side toward which the lead screw 4 protrudes is defined as a non-output side L2. In addition, with respect to an axis L direction, a direction in which support units 2c and 2b of a frame 2 extend is defined as an X direction, and a direction orthogonal to the X direction and the axis L direction is defined as a Y direction. Furthermore, regarding the X direction, a direction in which a terminal pin 82 protrudes is defined as an X1 direction, and a direction opposite to the X1 direction is defined as an X2 direction.

The motor 1 includes the lead screw 4 including an outer peripheral surface having a spiral groove formed therein, a drive unit 3 for rotationally driving the lead screw 4 around the axis L, a movable member 6 that engages with the spiral groove and moves in the axis L direction, and the frame 2 that supports the drive unit 3 etc. A guide shaft 5 arranged in parallel with the lead screw 4 and along the axis L direction is fixed to the frame 2. The drive unit 3 is a motor such as a stepping motor, and generally formed by a stator 14 forming the motor case and a rotor (not illustrated) arranged inside the stator 14. The rotor includes the shaft 19 and a permanent magnet (not illustrated) fixed to the shaft 19.

The stator 14 is fixed to the support unit 2b of the frame 2 on the non-output side L2 in the axis L direction, by using, for example, welding processing. A substrate holding member 60 holding the power supply substrate 70 is fixed to the support unit 2b by screws 18a and 18b.

The terminal pin 82 serving as a power feeding unit is provided in the side surface of the stator 14 and electrically connected to the power supply substrate 70. A terminal portion (not illustrated) of the drive coil of the stator 14 is wound around the terminal pin 82. The terminal pin 82 is soldered to the power supply substrate 70 to achieve electrical connection between the power supply substrate 70 and the drive coil.

A position detector 50 is attached to the power supply substrate 70. The position detector 50 is a push switch type position detector that detects a position of the origin in the moving direction (axis L direction) of the movable member 6. By soldering terminal pins 52a and 52b of the position detector 50 to the power supply substrate 70, the position detector 50 is electrically connected to the power supply substrate 70.

The frame 2 includes a plate-like frame main body 2a and a pair of support units 2b and 2c which are formed by bending both longitudinal ends of the frame main body 2a. The frame 2 is fixed to, for example, a mating device by using a hole 2g formed in the frame main body 2a. The drive unit 3 is fixed to the support unit 2b that is on the non-output side L2 in the axis L direction.

The lead screw 4 is formed integrally with the shaft 19 of the drive unit 3, and formed by a part of the shaft 19 (a portion protruding from the stator 14 toward the output side L1 in the axis L direction) of which the outer peripheral surface has a spiral groove formed therein. Therefore, the lead screw 4 is rotationally driven by the drive unit 3. The lead screw 4 is disposed in substantially parallel with the frame main body 2a. The tip of the lead screw 4 on the output side L1 in the axis L direction is rotatably supported by a bearing 7a provided on the support unit 2c of the frame 2 on the output side L1 in the axis L direction. Further, the end unit of the shaft 19 on the non-output side L2 in the axis L direction is rotatably supported by a bearing 7b attached to the drive unit 3, and an urging member 7c formed by a leaf spring urges the tip of the end unit toward the output side L1 in the axis L direction. The guide shaft 5 is arranged in parallel with the lead screw 4, and both ends of the guide shaft 5 are fixed to the support units 2b and 2c of the frame 2, respectively. In the present embodiment, the guide shaft 5 is coincident with the lead screw 4 when viewed along the X direction.

The movable member 6 includes a nut unit 40 that meshes with the lead screw 4 and moves in the axis L direction, a main body unit 9 that moves together with the nut unit 40 in the axis L direction, and a support unit 10 that is provided above the main body unit 9 and supports a protruding piece 132a of a mirror holder that is a member to be supported. The main body unit 9 includes a guide hole 8 through which the guide shaft 5 extends and a nut placement unit 11 in which the nut unit 40 is disposed. As the drive unit 3 rotates the lead screw 4, the nut unit 40 correspondingly reciprocates in the axis L direction and thus the movable member 6 reciprocates in the axis L direction while being guided by the guide shaft 5.

The nut unit 40 includes a first nut member 41 and a second nut member 43, each of which screwed with the lead screw 4, and a coil spring 42. The coil spring 42 is disposed between the first nut member 41 and the second nut member 43 and applies a preload such that the first nut member 41 and the second nut member 43 are away from each other.

The support unit 10 includes an elastic support unit 20 and a fixed support unit 30 that is on the non-output side L2 in the axis L direction and is opposite to the elastic support unit 20. The elastic support unit 20 urges the protruding piece 132a of the mirror holder toward the non-output side L2 in the axis L direction. The fixed support unit 30 supports the protruding piece 132a urged by the elastic support unit 20. The elastic support unit 20 includes an elastic member 21 that is in contact with the protruding piece 132a of the mirror holder and urges the protruding piece 132a toward the fixed support unit 30, and an elastic member fixing unit 22 that fixes the elastic member 21. The elastic member 21 is formed by a leaf spring, and a protruding piece contact unit 25c in contact with the protruding piece 132a is positioned at an end of elastic member 21. The elastic member fixing unit 22 is made of a synthetic resin material such as polyacetal, and is formed integrally with the main body unit 9. The fixed support unit 30 is made of a metal such as stainless steel. The fixed support unit 30 is formed of a material having higher rigidity than the main body unit 9 made of resin. The fixed support unit 30 is formed integrally with the main body unit 9 by using insert molding processing. A support protrusion 31a is formed in the fixed support unit 30. The support protrusion 31a protrudes toward the elastic support unit 20 that is on the output side L1 in the axis L direction and opposite to the fixed support unit 30. Therefore, in the present embodiment, the protruding piece 132a is supported by the support protrusion 31a and the contact piece contact unit 25c.

(Structure for Attaching Power Supply Substrate)

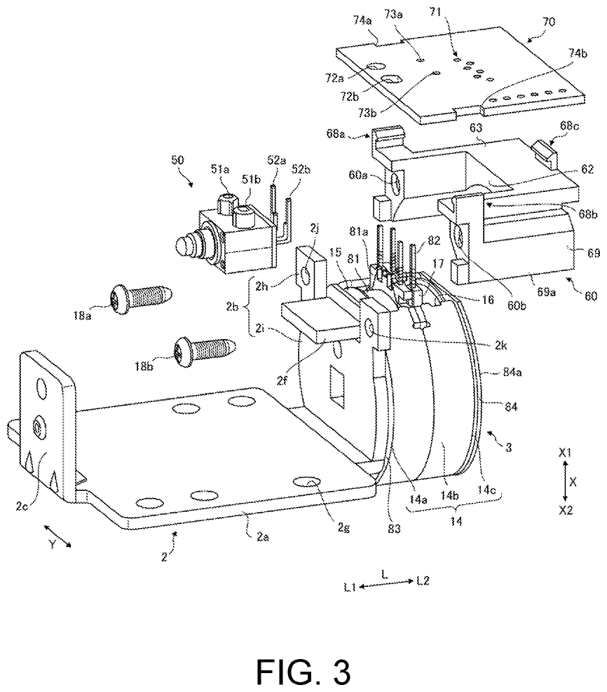

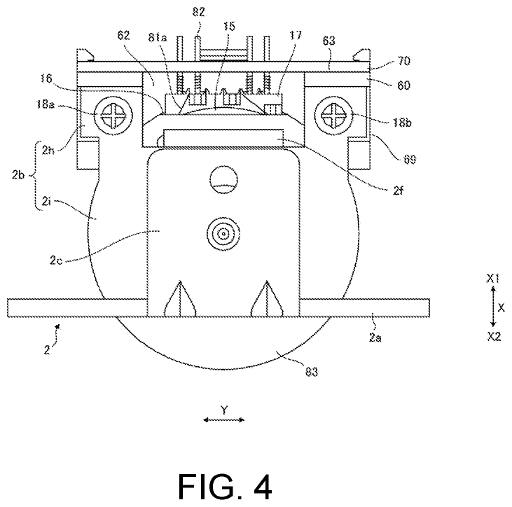

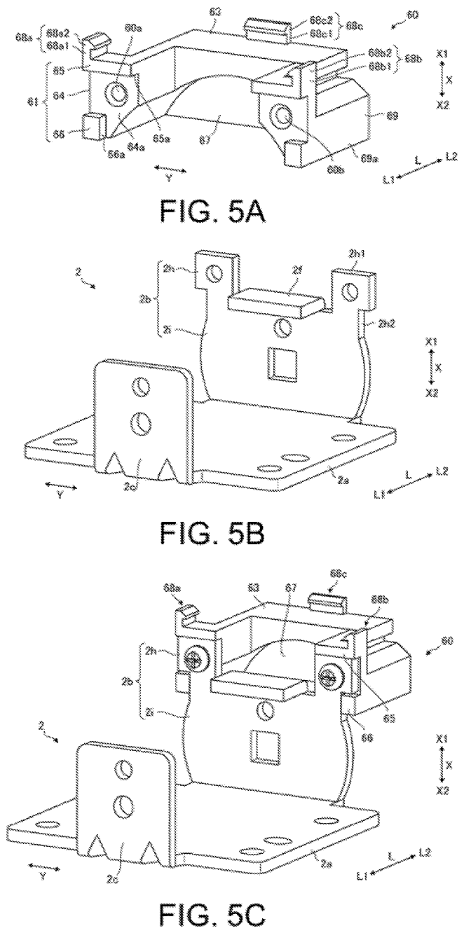

Hereinafter, with reference to FIGS. 3 to 5, a structure for attaching the power supply substrate 70 to the motor 1 will be described. FIG. 3 is a schematic exploded perspective view of the motor according to the present embodiment. FIG. 4 is a schematic front view of the motor according to the present embodiment. It is noted that, in FIG. 3, the lead screw 4, the guide shaft 5, the movable member 6, and the nut unit 40 are not illustrated, and, in FIG. 4, the lead screw 4, the guide shaft 5, the movable member 6, the nut unit 40, and the position detector 50 are not illustrated. FIG. 5(a) is a schematic perspective view of the substrate holding member in the present embodiment, FIG. 5(b) is a schematic perspective view of the frame in the present embodiment, and FIG. 5(c) is a schematic perspective view of the substrate holding member in the present embodiment that is fixed to the support unit of the frame.

A coil bobbin 15 is housed inside the motor case 14, and a drive coil 81 is formed by a coil wire 81a wound around the coil bobbin 15. The drive coil 81 is surrounded by a cylindrical outer peripheral surface of the motor case 14. An opening unit 16 is formed in the cylindrical outer peripheral surface of the motor case 14, and a terminal block 17 formed integrally with the coil bobbin 15 is provided so as to protrude, through the opening unit 16, radially outward with respect to the cylindrical outer peripheral surface. It is noted that the opening unit 16 is formed in the motor case 14 so as to be spaced away from the terminal block 17 by a predetermined distance. The terminal pin 82 is fixed to the terminal block 17, and a terminal portion of the drive coil 81 (an end unit of the coil wire 81a led out from the drive coil 81) is wound around and soldered to the terminal pin 82.

The motor case 14 includes an end surface 14a on one side (the output side L1) in the axis L direction, a cylindrical outer peripheral surface 14b, and an end surface 14c on the other side (the non-output side L2) in the axis L direction. The motor case 14 is fixed, by using, for example, welding processing, to the support unit 2b of the frame 2 on the non-output side L2 in the axis L direction, with the plate 83 fixed to the end surface 14a on the one side being interposed between the motor case 14 and the support unit 2b. The substrate holding member 60 is fixed to the support unit 2b. Specifically, the substrate holding member 60 is fixed to the support unit 2b by a pair of screws 18a and 18b fastened, from the support unit 2b side, to screw holes 60a and 60b of the substrate holding member 60. Details of a method for fixing the substrate holding member 60 will be described below.

The substrate holding member 60 includes a cutout unit 62 through which the terminal pin 82 passes toward the power supply substrate 70, and a substrate placement unit 63 on which the power supply substrate 70 is disposed. The substrate placement unit 63 is provided at the outer periphery of the cutout unit 62 so as to surround at least a part of the cutout unit 62. As a result, it is possible to reduce the possibility that the substrate holding member 60 comes into contact with the terminal block 17 or the terminal pin 82. In the present embodiment, the cutout unit 62 is cut out from the output side L1 of the substrate holding member 60 toward the non-output side L2, and the substrate placement unit 63 is formed on the non-output side L2 of the cutout unit 62 and both sides of the cutout unit 62 in the Y direction orthogonal to the axis L direction.

The substrate holding member 60 includes a wall unit 69 that extends from the substrate placement unit 63 toward the cylindrical outer peripheral surface 14b of the motor case 14. The edge unit 69a of the wall unit 69 extends beyond the opening unit 16 in the direction (X2) opposite to the direction (X1) in which the terminal pin 82 protrudes, and covers a part of the cylindrical outer peripheral surface 14b. As a result, it is possible to prevent dust etc. from entering the inside of the motor case 14 through the opening unit 16. In the present embodiment, the edge unit 69a of the wall unit 69 faces the cylindrical outer peripheral surface 14b of the motor case with a gap interposed therebetween. In other words, the edge unit 69a of the wall unit 69 and the cylindrical outer peripheral surface 14b are arranged so as to face each other in the X direction without contacting with each other.

The substrate holding member 60 includes an end plate unit 67 that covers an end surface 84a on the other side (non-output side L2) of the motor 1 (in the present embodiment, an end surface of a plate 84 fixed to the end surface 14c of the motor case 14 on the other side). The end plate unit 67 extends in the X2 direction from the end unit of the substrate placement unit 63 on the non-output side L2. In the present embodiment, the end plate unit 63 faces the end surface of the motor case 14 with a gap interposed therebetween. In other words, the end plate unit 67 and the end surface 84a of the motor 1 on the other side are arranged so as to face each other in the axis L direction without contacting with each other. However, in another embodiment, to hold the substrate holding member 60 in a stable orientation, the end plate unit 67 may be arranged so as to be, in the axis L direction, in contact with the end surface 84a of the motor 1 on the other side.

The substrate holding member 60 includes a substrate holding member side fixing unit for fixing the substrate holding member 60 to the support unit 2b of the frame 2. The substrate holding member side fixing unit 61 includes a first contact unit 64 in contact with the support unit 2b of the frame 2 in the axis L direction, a second contact unit 65 in contact with the support unit 2b in the X direction, and a third contact unit 66 in contact with the support unit 2b in the Y direction.

The first contact unit 64 is formed by an end surface facing the output side L1 of the wall unit 69, and includes a first contact surface 64a that can form a surface contact with the support unit 2b of the frame 2. The screw holes 60a and 60b extending from the output side L1 toward the non-output side L2 in the axis L direction are formed in the first contact surface 64a. The second contact unit 65 protrudes from the first contact unit 64 toward the output side L1 in the axis L direction, and includes a second contact surface 65a that is formed by an end surface facing the X2 direction and that can form a surface contact with the support unit 2b of the frame 2. The second contact surface 65a is orthogonal to the first contact surface 64a. It is noted that the second contact unit 65 is formed continuously with the substrate placement unit 63, and an end surface of the second contact unit 65 that faces the X1 direction forms a part of the substrate placement unit 63. The third contact unit 66 protrudes from the first contact unit 64 toward the output side L1 in the axis L direction, and includes a third contact surface 66a that is formed by end surfaces facing each other in the Y direction and can form a surface contact with the support unit 2b of the frame 2. The third contact surface 66a is orthogonal to the first contact surface 64a.

On the other hand, the support unit 2b of the frame 2 includes a first attachment unit 2h to which the substrate holding member 60 is attached and a second attachment unit 2i to which the motor case 14 is attached. The first attachment unit 2h is formed in a substantially rectangular shape, and includes holes 2j and 2k penetrating through the first attachment unit 2h in the axis L direction. When the substrate holding member 60 is fixed to the frame 2, an end surface of the first attachment unit 2h on the non-output side L2 comes into contact with the first contact unit 64. As a result, in the axis L direction, the substrate holding member 60 can be positioned with respect to the frame 2. Further, when the substrate holding member 60 is fixed to the frame 2, an edge unit 2h1 of the first attachment unit 2h that faces the X1 direction comes into contact with the second contact unit 65. As a result, in the X direction, the substrate holding member 60 can be positioned with respect to the frame 2. Further, when the substrate holding member 60 is fixed to the frame 2, a side edge unit 2h2 of the first attachment unit 2h that faces the Y direction comes into contact with the third contact unit 66. As a result, in the Y direction, the substrate holding member 60 can be positioned with respect to the frame 2.

As described above, the substrate holding member 60 is fixed so as to be positioned with respect to the frame 2 in each of the axis L direction, the X direction, and the Y direction. Specifically, the substrate holding member 60 is fastened by using the screws 18a and 18b attached through the holes 2j and 2k of the first attachment unit 2h into the screw holes 60a and 60b provided in the first contact unit 64, and, as a result, the substrate holding member 60 is fixed to the frame 2. The method for fixing the substrate holding member 60 to the frame 2 is not limited to the method using screws described above, and may be a method using an adhesive, for example.

The power supply substrate 70 is disposed on the substrate placement unit 63 of the substrate holding member 60. The power supply substrate 70 is held by the substrate holding member 60 with a predetermined gap being provided between the power supply substrate 70 and the terminal block 17. With that arrangement, it is possible to reduce the possibility that the power supply substrate 70 comes into contact with the terminal block 17.

The substrate placement unit 63 is provided with a plurality of engaging claw units 68a to 68c that engage with the power supply substrate 70. The engaging claw units 68a to 68c include extending units 68a1, 68b1, and 68c1 extending, in the X1 direction, from the upper surface (substrate placement unit) 63 of the substrate holding member 60 and claw unit 68a2, 68b2, and 68c2 in contact with an end surface (upper surface) of the power supply substrate 70 on the X1 direction side, respectively. In the present embodiment, the two side engaging claw units 68a and 68b, are provided at both edge units of the substrate holding member 60 in the Y direction, respectively, so as to be opposite to each other, and one rear edge engaging claw unit 68c is provided at the edge unit of the substrate holding member 60 on the non-output side L2 in the axis L direction. Correspondingly, cutout units 74a and 74b into which the side engaging claw units 68a and 68b are fitted, respectively, are formed at the outer peripheral edge of the power supply substrate 70. The cutout units 74a and 74b have substantially the same width (length in the axis L direction) as the extending units of the side engaging claw units 68a and 68b, and these extending units are received in the cutout units 74a and 74b. As a result, the power supply substrate 70 is positioned with respect to the substrate placement unit 63.

The terminal pin 82 of the motor 1 is electrically connected to the power supply substrate 70 in the following manner. The terminal pin 82, around which the terminal portion of the drive coil 81 (the end unit of the coil wire 81a led out from the drive coil 81) is wound and which is soldered to the terminal portion, extends through the cutout unit 62 provided in the substrate holding member 60 and electrically connected to the power supply substrate 70. Specifically, the terminal pin 82 extending through the cutout unit 62 is inserted into a terminal hole 71 formed in the power supply substrate 70, and soldered to the power supply substrate 70, and thereby the coil wire of the drive coil 81 is electrically connected to the power supply substrate 70.

Further, the position detector 50 is attached to the power supply substrate 70. Specifically, the position detector 50 includes a pair of engaging protrusions 51a and 51b, and the engaging protrusions 51a and 51b are fitted into a pair of engaging holes 72a and 72b formed in the power supply substrate 70, respectively. As a result, the position detector 50 is attached and fixed to the power supply substrate 70. In addition, by inserting the terminal pins 52a and 52b of the position detector 50 into terminal holes 73a and 73b formed in the power supply substrate 70, respectively, and soldering the terminal pins 52a and 52b to the power supply substrate 70, the position detector 50 is electrically connected to the power supply substrate 70. In the present embodiment, a drop-off prevention unit 2f is provided under the position detector 50, in other words, so as to be opposed to the power supply substrate 70 with the position detector 50 interposed therebetween. The drop-off prevention unit 2f prevents the position detector 50 from dropping off in case where the position detector 50 is detached from the power supply substrate 70. The drop-off prevention unit 2f is a plate unit formed by bending a part of the support unit 2b, and arranged such that a predetermined gap (clearance) is formed between the drop-off prevention unit 2f and the position detector 50.

As described above, the substrate holding member 60 and the motor case 14 are fixed with respect to the frame 2 as a center (base) component, and thus accuracy in positioning of the power supply substrate 70 can be improved. Furthermore, since the position detector 50 is attached to the above-described power supply substrate 70, the position detector 50 can be accurately attached in relation to the attachment hole 2g formed in the frame 2.

In the embodiment described above, the case where the substrate holding member 60 is fixed to the support unit 2b of the frame 2 having a U-shaped cross section is described as an example, but the present invention is not limited to the example. Thus, the present invention is also applicable to a case where the substrate holding member is fixed to a flat plate like frame.

### DESCRIPTION OF REFERENCE NUMERALS

1: Motor, 2: Frame, 2f: Drop-off prevention unit, 2h: First attachment unit, 2i: Second attachment unit, 6: Movable member, 14: Motor case, 14b: Cylindrical outer peripheral surface, 16: Opening unit, 17: Terminal block, 50: Position detector, 52a, 52b: Terminal pin, 60: Substrate holding member, 62: Cutout unit, 63: Substrate placement unit, 64: First contact unit, 65: Second contact unit, 66: Third contact unit, 67: End plate unit, 68a, 68b: Side engaging claw unit, 68c: Rear edge engaging claw unit, 69: Wall unit, 69a: Edge unit, 70: Power supply substrate, 74a, 74b: Cutout unit, 81: Drive coil, 81a: Coil wire, 82: Terminal pin

1. A motor, comprising:
a motor case including an opening unit formed therein, the motor case housing a drive coil;
a frame, attached to the motor case;
a substrate holding member, fixed to the frame; and
a power supply substrate, held by the substrate holding member,
wherein a coil wire of the drive coil is led out through the opening unit and is electrically connected to the power supply substrate.

2. The motor according to claim 1, wherein the motor case comprises:
a cylindrical outer peripheral surface surrounding the drive coil, and the opening unit is provided in the cylindrical outer peripheral surface;
a terminal block protruding, through the opening unit, radially outward with respect to the cylindrical outer peripheral surface; and
a terminal pin, held by the terminal block and wound with the coil wire,
wherein the power supply substrate is held by the substrate holding member with a predetermined gap being provided between the power supply substrate and the terminal block.

3. The motor according to claim 2, wherein the substrate holding member comprises:
a cutout unit, through which the terminal pin extends; and
a substrate placement unit, on which the power supply substrate is disposed,
wherein the substrate placement unit is provided at an outer periphery of the cutout unit.

4. The motor according to claim 3, wherein the substrate holding member comprises:
a wall unit, extending from the substrate placement unit toward the cylindrical outer peripheral surface;
wherein an edge unit of the wall unit extends beyond the opening unit in a direction opposite to a direction in which the terminal pin protrudes, and covers at least a part of the cylindrical outer peripheral surface.

5. The motor according to claim 1, wherein the frame comprises:
a first attachment unit to which the substrate holding member is attached; and
a second attachment unit to which the motor case is attached,
wherein a rotor is disposed inside the motor case, and
the substrate holding member includes a first contact unit in contact with the first attachment unit in an axial direction of the rotor.

6. The motor according to claim 5, wherein the substrate holding member comprises:
a second contact unit, protruding in the axial direction from the first contact unit,
wherein the second contact unit is in contact with the first attachment unit in a direction in which a terminal pin protrudes.

7. The motor according to claim 5, wherein the substrate holding member comprises:
a third contact unit, protruding in the axial direction from the first contact unit,
wherein the third contact unit is in contact with the first attachment unit in a direction orthogonal to the axial direction and a direction in which a terminal pin protrudes.

8. The motor according to claim 3, wherein
the substrate placement unit is provided with a plurality of engaging claw units engaging with the power supply substrate, and
a cutout unit into which each of the engaging claw units fits is formed in an outer peripheral edge of the power supply substrate.

9. The motor according to claim 8, wherein each of the engaging claw units comprises:
an extending unit, extending from the substrate placement unit; and
a claw unit, provided at an end of the extending unit and being in contact with the power supply substrate,
wherein the extending unit is fitted in the cutout unit.

10. The motor according to claim 1, wherein
the frame is attached to the motor case on one side in the axial direction of the motor, and
the substrate holding member includes an end plate unit partially covering an end surface of the motor on a different side in the axial direction of the motor.

11. The motor according to claim 10, wherein
the end plate unit is in contact with the end surface on the different side.

12. The motor according to claim 1, further comprising:
a movable member, configured to be moved by driving force by the motor; and
a position detector, configured to detect a movement position of the movable member,
wherein the position detector is attached to the power supply substrate.

13. The motor according to claim 12, wherein the frame comprises:
a plate unit, being opposed to the power supply substrate with the position detector interposed therebetween,
wherein the plate unit faces the position detector with a predetermined gap formed therebetween.
